(19) United States
(12) Patent Application Publication
(10) Pub. No.: US 2015/0122461 A1
(43) Pub. Date: May 7, 2015

(54) Medium for Boiling-Type Cooler and Method of Using Same

(71) Applicant: Central Glass Company, Limited, Ube-shi, Yamaguchi (JP)

(72) Inventors: Yoshio Nishiguchi, Kawagoe-shi (JP); Satoru Okamoto, Kawagoe-shi (JP); Fuyuhiko Sakyu, Kawagoe-shi (JP)

(21) Appl. No.: 14/395,274

(22) PCT Filed: Feb. 26, 2013
(86) PCT No.: PCT/JP2013/054839

§ 371 Date: Oct. 17, 2014

(30) Foreign Application Priority Data
Apr. 19, 2012 (JP) 2012-095246

(51) Int. Cl. C09K 5/04; F28D 15/02; F25B 9/00

(52) U.S. Cl. CPC C09K 5/048; F25B 9/002; F28D 15/02
USPC 165/104.21; 62/56; 252/67; 568/683

(57) ABSTRACT

A working medium containing 2-methoxy-1,1,1,3,3,3-hexafluoropropane (HFE-356mmz) as a main component is disclosed. This working medium is a new working medium for a boiling-type cooler, which has a light burden on the environment such as the global warming potential, etc., is slightly flammable or flame retardant, has superior thermal and chemical stabilities, and a good compatibility with heat exchangers formed of various metal materials. This medium for the boiling-type cooler can be preferably used as a working medium for a cooler of a PCU (power control unit) of a car.

### TECHNICAL FIELD

The present invention relates to a medium for a boiling-type cooler, comprising 2-methoxy-1,1,1,3,3,3-hexafluoropropane (HFE-356mmz) as a main component, and a method of using the same.

### BACKGROUND OF THE INVENTION

A heat exchanger of a type of boiling cooling has been known which cools down a semiconductor device, an electronic apparatus, etc. using latent heat of vaporization of a working medium sealed in a heat exchanger such as heat pipe, etc. In addition, in the present specification, a medium for a boiling-type cooler may be simply called a working medium.

Until now, water, ethanol, chlorofluorocarbon, ammonia, etc. have been used as a working medium for a heat exchanger of a type of boiling cooling using latent heat. Water is an excellent working medium in points of a large liquid latent heat, good handling, high safety, etc. However, in practical use, there are problems such as operation instability and freezing in a cold district due to a high freezing point, etc.

Ammonia has problems such as damage to a container made of copper, the stink at the time of leaking and toxicity. Ethanol causes damage to an aluminium container and a stainless steel container. Chlorofluorocarbon has been used as a working medium which is comparatively stable and excellent in heat transfer efficiency. However, from the viewpoint of burden on the environment, such as ozone layer depletion by chlorofluorocarbon in the atmosphere, there is a fear about the future use.

Based on such background, hydrocarbon-series working mediums have been known as alternative chlorofluorocarbon, which have a low environmental load relating to ozone depletion potential and global warming potential, etc. For example, in Patent Publication 1, it has been disclosed that hydrocarbons such as n-pentane are used as a working medium of a heat pipe made of aluminium.

There are conducted various examinations that HFE (hydrofluoroether) series compounds as other alternative working mediums are used as a working medium for heat pipe.

For example, Patent Publication 2 discloses that HFE (hydrofluoroether) such as 1,1,2,2-tetrafluoroethyl-2,2,2-trifluoroethyl ether (HFE-347 pc-f), etc. is used for a heat exchanger such as heat pipe, etc. and discloses an operation method of the heat exchanger.

Furthermore, in Patent Publication 3, a heat pipe is disclosed, in which a working medium (it is also called working fluid) comprising a mixture of HFC-134a and HFE-347 pc-f is sealed in a container, and in which the mixing ratio between HFC-134a and HFE-347 pc-f in the working medium is 0.5-1.5 volume % of HFE-347 pc-f relative to 100 volume % of HFC-134a at normal temperature.

### PRIOR ART REFERENCES

### Patent Publications

Patent Publication 1: Japanese Patent Application Publication 2001-55564
Patent Publication 2: Japanese Patent Application Publication 2006-307170
Patent Publication 3: Japanese Patent Application Publication 2010-65879

### SUMMARY OF THE INVENTION

In Patent Publications 1-3, it has been disclosed that compounds of hydrocarbons and HFE series are used for a working medium. However, under the present situation, these compounds are not yet sufficient, as a whole from the viewpoint of burden on the environment, nonflammability, toxicity, cooling performance of the working medium, operating pressure of the working medium, etc.

Accordingly, the purpose of the present invention is to provide a new working medium for a boiling-type cooler.

In short, the present invention is a medium for boiling-type cooler, comprising 2-methoxy-1,1,1,3,3,3-hexafluoropropane (in the following it is called HFE-356mmz) as a major component. In addition, in the present specification, HFE-356mmz means 2-methoxy-1,1,1,3,3,3-hexafluoropropane.

Moreover, a medium for a boiling-type cooler of the present invention can be used suitably as a working medium of a cooler for a PCU (power control unit) of a car.

### Effects of the Invention

According to the present invention, it is possible to provide a medium for a boiling-type cooler that is superior as a whole in terms of burden on the environment, nonflammability, toxicity, cooling performance of the working medium, etc.

### BRIEF EXPLANATION OF THE DRAWINGS

FIG. 1 is a schematic diagram of an experimental apparatus which is used for examples and comparative examples.

FIG. 2 is a graph that shows the relation between input heat quantity (W) and working fluid thermal resistance (° C./W).

FIG. 3 is a graph that shows the relation between input heat quantity (W) and working pressure (MPa).

FIG. 4 is an enlarged figure of FIG. 2.

### DETAILED DESCRIPTION

In the following, a boiling-type cooler is explained, to which a working medium of the present invention can be applied. A boiling-type cooler in the present specification means a cooling system using latent heat of vaporization of a working medium in phenomena of evaporation, boiling, condensation, etc. of a working medium.

The boiling-type cooler is a cooling system having a heat receiving part in which a working medium (liquid) stored inside of a pressure-resistance, airtight container, etc. is boiled by receiving heat from a heating element, and a radiation part to radiate heat of the working medium (vapor) boiled at the heat receiving part to the outside. As the principle, the cooling effect is achieved by changing phases of the working medium by boiling and condensation (see the after-mentioned Examples 1-3). In addition, in the present invention, driving power to circulate the working fluid in the boiling-type cooler is not especially limited, for example, a method of using gravity or capillary force, a method of using a mechanical work of pumps, etc.

Next, HFE-356mmz is explained.

<HFE-356mmz>

HFE-356mmz is extremely small in the ozone depletion potential (ODP) and the global warming potential (GWP) because it includes an ether oxygen in its molecule and is highly reactive with hydroxyl radicals. Therefore, burden on the environment is small. Moreover, HFE-356mmz is slightly flammable or flame retardant and has no toxicity. In addition, boiling point of HFE-356mmz is 50° C. under the atmospheric pressure, the atmospheric lifetime is 2.0 months (The Journal of Physical Chemistry A 2005, 109, 4766-4711), and the global warming potential (GWP) is 25 (Environmental Science & Technology 2008, 42, 13011307).

HFE-356mmz is a known compound written in references. For example, HFE-356mmz can be obtained under the presence of an alkali by reacting 1,1,1,3,3,3-hexafluoroisopropyl alcohol with dimethyl sulfate (U.S. Pat. No. 3,346,448). Moreover, HFE-356mmz can be obtained by heating decomposition of methyl 3,3,3-trifluoro-2-trifluoromethyl-2-methoxypropionate as a starting raw material using an organic base as a catalyst (Japanese Patent Application Publication 2011-116661).

HFE-356mmz can be used singly. Other compounds may suitably be added as needed, to the extent of not damaging the effect of the working medium of the present invention. In the working medium (100 mass %), HFE-356mmz is preferably contained as a main component by 50 mass % or greater, preferably 75 mass % or greater, more preferably 80 mass % or greater. In case of being less than 50 mass %, it becomes difficult to sufficiently obtain the effects (stability, cooling performance, etc. of the working medium) of the working medium of the present invention.

As other compounds added to HFE-356mmz, it is optional to add other additive compounds, such as fluorinated ethers, fluorinated olefins, halocarbons (HC), hydrofluorocarbons (HFC), hydrocarbons such as alcohol and saturated hydrocarbon, lubricant oil, stabilizer, etc. Moreover, these additive compounds can be used as a single substance or a mixture of at least two kinds of those listed below. In addition, it is preferable to make these compounds 50 mass % or lower in the working medium.

In the following, other additive compounds are explained.

<Fluorinated Ethers>

As other fluorinated ethers, it is possible to list trans-1-methoxy-3,3,3-trifluoropropene (CF₃CH═CHOCH₃: 62° C. of boiling point), 1,1,2,2,-tetrafluoro-1-methoxyethane (CF₂HCF₂OCH₃: 37° C. of boiling point), 2,2,2-trifluoroethyl trifluoromethyl ether (CF₃CH₂OCF₃: 6° C. of boiling point), 3H-hexafluoropropyl trifluoromethyl ether (CHF₂CF₂CF₂OCF₃: 23-34° C. of boiling point), 2,2,3,3,3-pentafluoropropyl trifluoromethyl ether (CF₃CF₂CH₂OCF₃: 26° C. of boiling point), heptafluoro-1-methoxypropane (CF₃CF₂CF₂OCH₃: 34° C. of boiling point), heptafluoropropyl-1,2,2,2-tetrafluoroethyl ether (CF₃CF₂CF₂OCHFCF₃: 41° C. of boiling point), difluoromethyl-1,1,2,2,3,3,3-pentafluoropropyl ether (CF₃CF₂CF₂OCHF₂: 46° C. of boiling point), 1,1,2,3,3,3-hexafluoropropyl-difluoromethyl ether (CF₃CHFCF₂OCHF₂: 47° C. of boiling point), 1,2-dichlorotrifluoroethyl trifluoromethyl ether (CF₂ClCFClOCF₃: 41° C. of boiling point) and octafluoro-3-methoxypropene (CF₂═CFCF₂OCF₃: 10° C. of boiling point).

<Fluorinated Olefins>

It is possible to list cis-1,3,3,3-tetrafluoropropene (cis-CF₃CH═CHF: 9° C. of boiling point), trans-1,1,1,4,4,4-hexafluoro-2-butene (trans-CF₃CH═CHCF₃: 9° C. of boiling point), cis-1,1,1,4,4,4-hexafluoro-2-butene (cis-CF₃CH═CHCF₃: 33° C. of boiling point), trans-1,1,1,3,-tetrafluoro-2-butene (trans-CF₃CH═CFCH₃: 17° C. of boiling point), cis-1,1,1,3-tetrafluoro-2-butene (cis-CF₃CH═CFCH₃: 49° C. of boiling point), 1,1,2,3,3,4,4-heptafluoro-1-butene (CHF₂CF₂CF═CF₂: 21° C. of boiling point), 3-(trifluoromethyl)-3,4,4,4-tetrafluoro-1-butene ((CF₃)₂CFCH═CH₂: 23° C. of boiling point), 2,4,4,4-tetrafluoro-1-butene (CF₃CH₂CF═CH₂: 30° C. of boiling point), 3,3,3-trifluoro-2-(trifluoromethyl)-1-propene ((CF₃)₂CH═CH₂: 14° C. of boiling point), trans-1-chloro-3,3,3-trifluoropropene (trans-CF₃CH═CHCl: 19° C. of boiling point), cis-1-chloro-3,3,3-trifluoropropene (cis-CF₃CH═CHCl: 39° C. of boiling point), trans-1,2-dichloro-3,3,3-trifluoropropene (trans-CF₃CCl═CHCl: 60° C. of boiling point), cis-1,2-dichloro-3,3,3-trifluoropropene (cis-CF₃CCl═CHCl: 53° C. of boiling point), 1-chloro-pentafluoropropene (CF₃CF═CFCl: 8° C. of boiling point) and 2-chloro-3,3,3-trifluoropropene (CF₃CCl═CH₂: 15° C. of boiling point).

<Halocarbons (HC), Hydrofluorocarbons (HFC)>

As halocarbons, it is possible to list that methylene chloride, trichloroethylene and tetrachloroethylene, having halogen atoms. As hydrofluorocarbons, it is possible to list difluoromethane (HFC-32), 1,1,1,2,2-pentafluoroethane (HFC-125), fluoroethane (HFC-161), 1,1,2,2-tetrafluoroethane (HFC-134), 1,1,1,2-tetrafluoroethane (HFC-134a), 1,1,1-trifluoroethane (HFC-143a), difluoroethane (HFC-152a), 1,1,1,2,3,3,3-heptafluoropropane (HFC-227ea), 1,1,1,2,3-pentafluoropropane (HFC-236ea), 1,1,1,3,3,3-hexafluoropropane (HFC-236fa), 1,1,1,3,3-pentafluoropropane (HFC-245fa), 1,1,1,2,3-pentafluoropropane (HFC-245eb), 1,1,2,2,3-pentafluoropropane (HFC-245ca), 1,1,1,3,3-pentafluorobutane (HFC-365mfc), 1,1,1,3,3,3-hexafluoroisobutane (HFC-356mmz), 1,1,1,2,2,3,4,5,5,5-decafluoropentane (HFC-43-10-mee), etc.

<Alcohols>

As alcohols, it is possible to list methanol, ethanol, n-propanol, i-propanol, n-butanol, i-butanol, 2,2,2-trifluoroethanol, pentafluoropropanol, tetrafluoropropanol, etc., having 1 to 4 carbon atoms.

<Hydrocarbons>

As hydrocarbons, it is possible to list propane, butane, pentane, cyclopentane, methylcyclopentane, hexane and cyclohexane, having 3 to 8 carbon atoms and various isomers are applicable. For example, it is possible to mix at least one compound which is chosen from saturated hydrocarbons such as propane, n-butane, i-butane, neopentane, n-pentane, i-pentane, cyclopentane, methylcyclopentane, n-hexane, cyclohexane, etc. Among these compounds, it is possible to list as especially preferable substances neopentane, n-pentane, i-pentane, cyclopentane, methylcyclopentane, n-hexane, cyclohexane, etc.

In adding the above-mentioned hydrocarbons, it is preferable to adjust the preferable composition ratio at the time of mixing hydrocarbons by taking into account the global warming potential (GWP) of the working medium and the working pressure (boiling point of the working medium) in the use of a boiling-type cooler. Regarding the preferable composition ratio, it is preferable that the content by percentage of HFE-356mmz is 50-95 mass %, more preferably 65-90 mass %, and the content by percentage of the hydrocarbon is 5-50 mass %, more preferably 10-35 mass %.

Among the above-mentioned hydrocarbons, from the viewpoint of forming an azeotropic composition or azeotropic-like composition with HFE-356mmz, it is especially preferable to use cyclopentane, n-hexane and cyclohexane as the hydrocarbons. These compositions can be used especially preferably as a working medium for a boiling-type cooler of the present invention. By forming the azeotropic composition or the azeotropic-like composition, it is possible to minimize evaporation of the working medium, the temperature change at the time of condensation and the composition change of gas-liquid. Therefore, it is possible to improve stability of the working medium and suppress lowering of heat transfer efficiency.

In addition, in the present specification, the azeotropic composition is a composition that has no difference between the composition of liquid and that of gas phase under a constant pressure, acts like one substance and is not changed in composition of the composition after repeating evaporation and condensation. On the other hand, the azeotropic-like composition is that its vapor composition and its liquid composition are almost the same and that the composition change of the composition after repeating evaporation and condensation is at the level that can be ignored.

As a specific composition ratio of the azeotropic composition or the azeotropic-like composition, it is preferable to use a composition comprising 65-95 mass % of HFE-356mmz and 5-35 mass % of cyclopentane, a composition comprising 80-95 mass % of HFE-356mmz and 5-2 mass % of n-hexane or a composition comprising 85-95 mass % of HFE-356mmz and 5-15 mass % of cyclohexane. In particular, in case of using the above-mentioned composition as a working medium for a boiling-type cooler, it is possible to obtain a low heat resistance and a superior heat transfer characteristic of the working liquid (see the after-mentioned Examples).

<Stabilizer>

As a stabilizer to improve heat stability, oxidation resistance, etc., it is possible to list nitro compounds, epoxy compounds, phenolic compounds, imidazoles, amines, etc. In addition, it may include hydrocarbons such as α-methylstyrene, p-isopropenyltoluene, isoprenes, propadienes, terpenes, etc. As these compounds, it is enough to use those that are generally known.

The stabilizer may be added to the working medium in advance or may be added singly into the boiling-type cooler. Upon this, usage of the stabilizer is not particularly limited. Relative to the main working medium (100 mass %), 0.001-10 mass % is preferable, more preferably 0.01-5 mass %, still more preferably 0.02-2 mass %.

The working medium of the present invention can be widely applied to a cooling system such as a heat pipe using latent heat of vaporization of liquid, etc. For example, it can be used for a cooler of a semiconductor device, an electronic apparatus, etc. In particular, it can be preferably used as a working medium of a cooler for a PCU (power control unit) mounted on a vehicle such as a hybrid car and an electric car, etc. In the following, a cooler for the PCU (power control unit) mounted on a vehicle such as a hybrid car and an electric car, etc. is explained.

In electric cars, fuel cell vehicles, hybrid cars driven by using both of an internal-combustion engine (engine) and an electric motor, etc., units of motor, PCU (power control unit), batteries, etc. are added, as compared with a normal gasoline car. Therefore, so far, the weight is heavy, the living space is narrow, and the price is high.

The PCU (power control unit) is comprised of an inverter to drive and control a motor, a converter to boost battery voltage, etc. It is important to have downsizing, the reduced cost, and the improved performance of the inverter for spreading the next-generation environmental cars such as hybrid cars and electric cars, etc. To downsize an onboard inverter for a car, it is a task to suppress the energy loss by heat generation. Therefore, it is necessary to improve the cooling performance (the performance improvement of the cooler) of a power module in which many power semiconductors are integrated.

In using the cooler for the PCU, in addition to improving the cooling performance, as a specific performance necessary for the working medium, it is possible to list 1) the ozone depletion potential is zero (ODP=00); 2) the global warming potential is small (GWP<150); 3) flammability and toxicity are extremely low; 4) thermal stability is high with no decomposition or no change; and 5) compatibility with a material of a heat exchanger is good (for example, reactivity between the working medium and a material of a heat exchanger), etc.

To improve the cooling performance of the cooler (heat exchanger) for the PCU, a working medium having a low normal boiling point may be used to improve heat transfer efficiency. However, if the boiling point is too low, the inside pressure of the heat exchanger becomes high, thereby increasing burden on the container of the heat exchanger. Therefore, from the viewpoint of airtightness and pressure resistance performance of the device, a large device becomes necessary, thereby increasing the cost. On the other hand, if boiling point of the working medium becomes high, it becomes difficult to evaporate in case of a little input heat quantity and thereby heat resistance increase (heat transfer efficiency becomes low).

For example, in case of using a heat exchanger made of aluminium which has a fear about strength as a material, there is a fear about a high cost of a device by design change of the heat exchanger due to a problem of airtightness and pressure resistance. Therefore, from the viewpoint of burden on the container of the heat exchanger, in using the cooler for the PCU, it is an important element as well to use a working medium which is capable of keeping an appropriate working pressure. As an estimate of the appropriate working pressure, it is preferable that the working pressure is in a range of from fine decompression to fine compression. For example, the range is from 0 MPa to 4 MPa (absolute pressure), especially preferably from 0.05 MPa to 0.5 MPa.

In conventional working mediums of hydrocarbons and HFE series, currently, a medium for a boiling-type cooler having all of the performances of the above-mentioned 1)-5) has not yet been reported. Especially, if a chemical structure of HFE is different, the performance as the working medium is naturally changed. Therefore, there is a problem that it is not easy to specify a compound which can be used for a specific use.

The working medium having HFE-356mmz of the present invention as a main component has a light burden on the environment such as the global warming potential, etc. (ODP=0, GWP<150) and is slightly flammable or flame retardant, thereby having a high safety. Moreover, thermal and chemical stabilities are high with good compatibility with various metal materials (see heat stability tests of Examples). Furthermore, it is capable of keeping an appropriate working pressure without imposing a heavy burden on the heat exchanger (see Examples 1 to 4), thereby having all of the performances of the above-mentioned 1)-5). Therefore, the working medium of the present invention can be preferably used for the cooler of the PCU (power control unit) mounted on a vehicle such as a hybrid car, an electric car, etc.

In addition, in case of using the working medium of the present invention, various metal materials can be used as a material of the cooler (heat exchanger) for the PCU. For example, it is possible to list general metal materials such as aluminium, such as pure aluminium, aluminium alloys, etc., nickel, stainless steel, iron, copper, etc. Moreover, in case of using a metal having an aluminium component, it is preferable that the water content in the working medium is as little as possible (for example, 50 ppm or less) due to the reaction between the working medium and the metal.

<Usage>

The boiling-type cooler using the working medium of the present invention can be operated when the operating temperature corresponding to the input heat quantity is from −50 to 150° C., especially preferably from 0° C. to 100° C. For example, in the above range of the operating temperature, it is possible to set inside pressure of the heat exchanger at 0 MPa to 4 MPa. Therefore, it is possible to keep an appropriate operating pressure without imposing a heavy burden on the heat exchanger.

### EXAMPLES

In the following, the present invention is explained according to Examples, but the present invention is not limited to Examples. As Comparative example 1, a two-component refrigerant, which had been prepared by mixing water with ethanol to be used for a general conventional boiling-type cooler device, was used as a working medium. Moreover, as Comparative example 2, HFE-347 pc-f was used as a working medium of HFE series. In addition, in Examples, a working medium may be called working liquid.

### Example 1

30 mL of a working liquid comprising a mixture of HFE-356mmz and cyclopentane was enclosed into a container of a boiling-type cooler formed by a pipe-shape container made of SUS316 having an outside diameter of 16 mm, a thickness of 1.0 mm and a length of 800 mm. In addition, the mixing ratio by mass of HFE-356mmz to cyclopentane in the working liquid was 66.58:33.42.

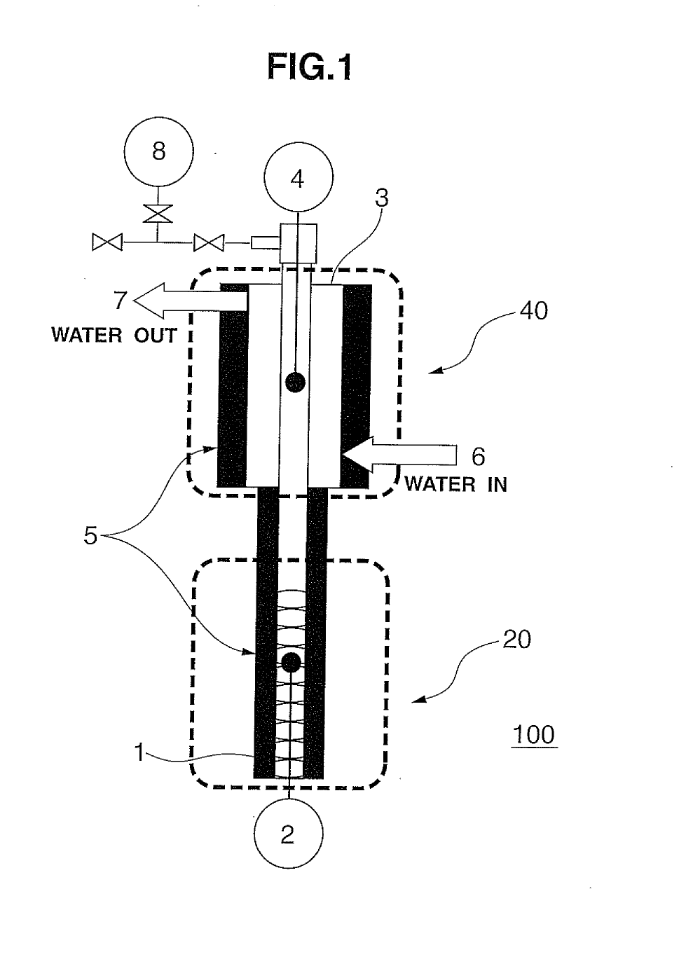

As shown in FIG. 1, an evaporation part 20 was prepared by coiling a sheathed heater 1 around approximately a half part of one end side of a boiling-type cooler 100, and covering with a heat insulator 5 for the purpose of equalizing temperature. Moreover, a condensation part 40 was prepared by equipping approximately a half part of the other end side of the boiling-type cooler 100 with a water cooling jacket 3 to put a distance in the longitudinal direction of the boiling-type cooler 100 from the sheathed heat 1. A heat insulating part is a part between the evaporation part 20 and the condensation part 40 in the boiling-type cooler 100.

A thermometer 2 of the evaporation part and a thermometer 4 of the condensation part were respectively installed in the evaporation part 20 and the condensation part 40, to measure the temperatures. To measure the inside pressure of the boiling-type cooler 100, a pressure gauge 8 was set. In addition, the input heat quantity to the evaporation part 20 was controlled by a Slidac.

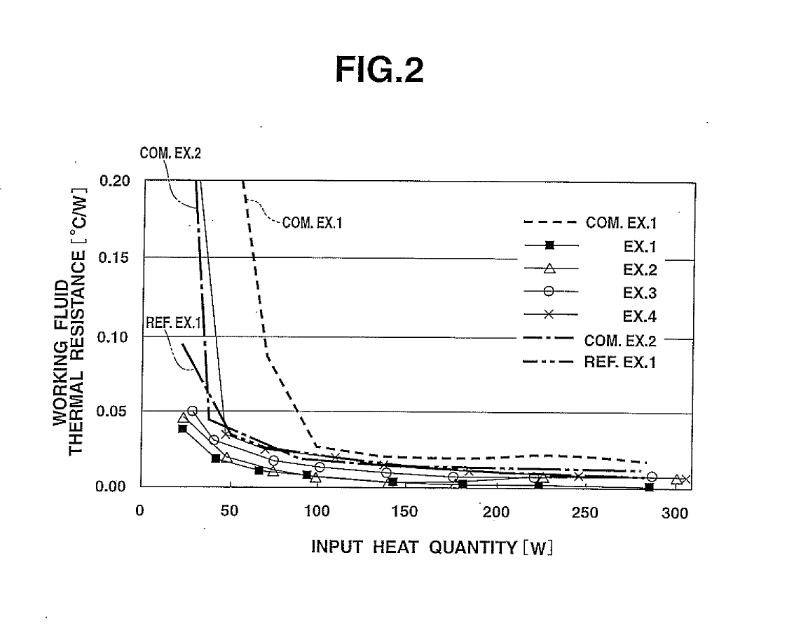

As shown in FIG. 1, the evaporation part 20 was down side, the condensation part 40 was up side, and the boiling-type cooler 100 was set vertically. The condensation part 40 was cooled down by supplying and circulating a cooling water (inlet temperature=25° C., supply rate=8.5 g/sec) into and through the water-cooling jacket 3 while heating the evaporation part 20 of the boiling-type cooler 100 by sheathed heater. The relation between the input heat quantity (W) and the working fluid thermal resistance (° C./W) in the boiling-type cooler 100 was determined by variously changing the input heat quantity (W) by the sheathed heater. The result is shown in FIG. 2. In addition, in the input heat quantity (W) in FIG. 2, as the corresponding operating temperature between 0 W and 300 W, the temperature of the inside of the boiling-type cooler is approximately 30 to 70° C.

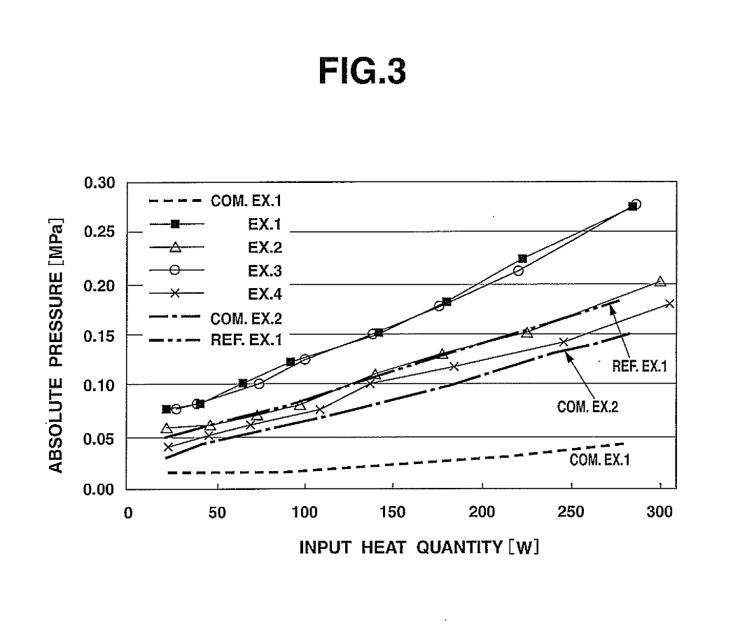

The working fluid thermal resistance (° C./W) was calculated by dividing the difference between the inside temperature in the centre of the evaporation part and the inside temperature in the centre of the condensation part by input heat quantity of the sheathed heater. The relation between the input heat quantity (W) and the working pressure in the boiling-type cooler was determined by variously changing the input heat quantity (W) by the sheathed heater. The result is shown in FIG. 3.

### Example 2

It was conducted under the same conditions as those of Example 1 except that the working fluid was a mixed composition of HFE-356mmz and n-hexane, and the mixing ratio by mass was 82.08:17.92.

### Example 3

It was conducted under the same conditions as those of Example 1 except that the working fluid was a mixed composition of HFE-356mmz and cyclopentane, and the mixing ratio by mass was 76.0:24.0.

### Example 4

It was conducted under the same conditions as those of Example 1 except using a medium of only HFE-356mmz as the working fluid.

### Comparative Example 1

It was conducted under the same conditions as those of Example 1 except that the working fluid was a mixed composition of water and ethanol, and the mixing ratio by mass was 50.0:50.0.

### Comparative Example 2

It was conducted under the same conditions as those of Example 1 except using a medium of only 1,1,2,2,-tetrafluoroethyl-2.2.2-trifluoroethyl ether (HFE-347 pc-f) as the working fluid.

### Reference Example 1

In addition, as a reference example, it was conducted under the same conditions as those of Example 1 except using a medium of only cyclopentane as the working fluid.

According to the result shown in FIG. 2, in Comparative Example 1, the thermal resistance increases sharply in 50 W or less of the input heat quantity of the sheathed heater. Therefore, it is understood that, in case of a small input heat quantity, it becomes difficult to evaporate the working fluid, and thereby heat transportation is not performed efficiently. In contrast with this, in Examples 1 to 4, in a range of the input heat quantity of the sheathed heater between 20 and 300 W, a sharp change of the thermal resistance was not observed. Moreover, in a wide range of the input heat quantity, the thermal resistance is smaller than Comparative Example 1. Therefore, it is understood that the heat transportation is performed efficiently. In addition, it is also understood that the working mediums of Examples 1 to 4 are superior in heat transfer efficiency to Comparative Example 2.

According to the result shown in FIG. 3, in Comparative Example 1, in a range of the input heat quantity between 20 to 300 W, it is understood that the inside of the boiling-type cooler has always atmospheric pressure or less, that is, negative pressure. In contrast with this, in Examples 1 to 4, in a range of the input heat quantity of the sheathed heater between 20 and 300 W, the inside pressure of the boiling-type cooler is from 0.05 to 0.30 MPa. Therefore, it is possible to say that the working pressure is excellent from the view point of pressure resistance performance of a material which composes the boiling-type cooler. Especially, it is understood that the proper working pressure is shown (Examples 1 and 3) by mixing HFE-356mmz with cyclopentane with a specified composition ratio.

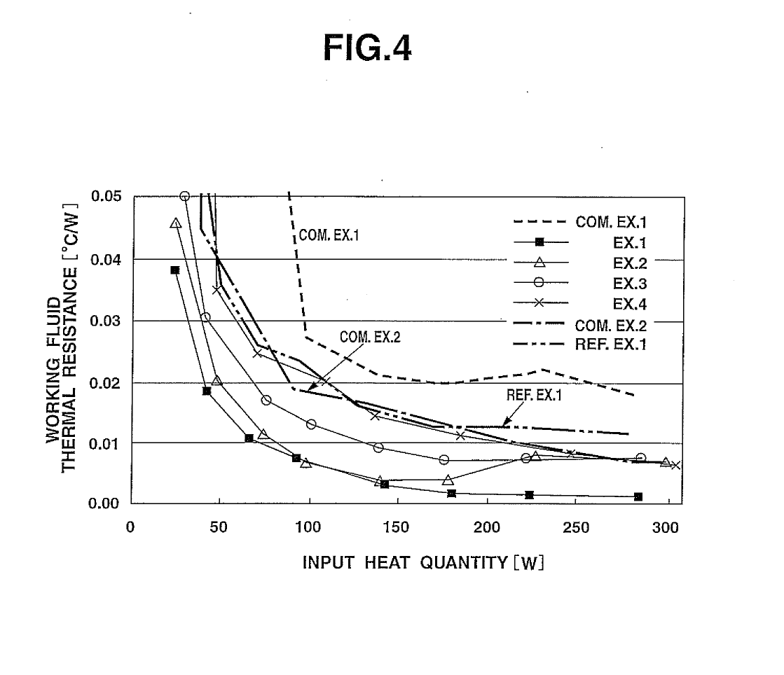

Furthermore, according to the result of the working fluid thermal resistance in FIG. 4, in cases of only HFE-356mmz (Example 4) and only cyclopentane (Reference Example 1), when they are respectively single, they have similar working fluid thermal resistances. However, amazingly, as shown in Example 1 and Example 3, the working fluid thermal resistance becomes particularly remarkably low due to mixing HFE-356mmz with cyclopentane with a specific composition ratio. Therefore, it is understood that heat transfer characteristic has improved when using as the boiling-type cooler.

In addition, a heat stability test was conducted using the working mediums shown in the following.

Example 1: HFE-356mmz/cyclopentane=66.58:33.42 (mixing ratio is mass ratio), Example 3: HFE-356mmz/cyclopentane=76.0:24.0 (mixing ratio is mass ratio) and Example 4: HFE-356mmz. In conformity with JIS-K-2211 a shield tube test of “refrigerating machine oil”, 1.0 g of the working medium and a piece of metal (each wire of iron, copper and aluminium) were sealed into a glass test tube and heated at 175° C., and kept for 2 weeks. Two weeks later, appearance, purity and acid content (F-ions) of the working medium were measured to evaluate heat stability. The result obtained is shown in Table 1.

TABLE 1

| | Example 1 | Example 3 | Example 4 |
|---|---|---|---|
| Appearance | Colourless and | Colourless and | Colourless and |
| | transparent | transparent | transparent |
| Purity | No change | No change | No change |
| Acid content | <1 | <1 | <1 |
| (ppm) | | | |

As is clear from the result shown in Table 1, it is understood that the working medium of the present invention is superior in heat stability and has an excellent affinity for iron, copper and aluminium.

### EXPLANATION OF SIGNS

100: a boiling-type cooler
20: an evaporation part
40: a condensation part
1: a sheathed heater
2: a thermometer of the evaporation part
3: a water-cooling jacket
4: a thermometer of the condensation part
5: a heat insulator
6: an inlet of a jacket cooling water
7: an outlet of a jacket cooling water
8: a pressure gauge

1. A medium for a boiling-type cooler comprising 2-methoxy-1,1,1,3,3,3-hexafluoropropane (“HFE-356mmz”) as a main component.

2. The medium for the boiling-type cooler according to claim 1, further comprising a C₃₋₈ hydrocarbon.

3. The medium for the boiling-type cooler according to claim 2, wherein the hydrocarbon is at least one saturated hydrocarbon selected from the group consisting of propane, butane, n-pentane, i-pentane, cyclopentane, methylcyclopentane, n-hexane and cyclohexane.

4. The medium for the boiling-type cooler according to claim 2, wherein a content by percentage of HFE-356mmz is 50-95 mass % and a content by percentage of the hydrocarbon is 5-50 mass %.

5. The medium for the boiling-type cooler according to claim 4, wherein the hydrocarbon is cyclopentane, and wherein the content by percentage of HFE-356mmz is 65-95 mass % and a content by percentage of the cyclopentane is 5-35 mass %.

6. The medium for the boiling-type cooler according to claim 4, wherein the hydrocarbon is n-hexane, and wherein the content by percentage of HFE-356mmz is 80-95 mass % and a content by percentage of the n-hexane is 5-20 mass %.

7. The medium for the boiling-type cooler according to claim 4, wherein the hydrocarbon is cyclohexane, and wherein the content by percentage of HFE-356mmz is 85-95 mass % and a content by percentage of the cyclohexane is 5-15 mass %.

8. The medium for the boiling-type cooler according to claim 1, wherein the boiling-type cooler is a cooler for a PCU of a car.

9. The medium for the boiling-type cooler according to claim 1, wherein the boiling-type cooler is a cooler of an electronic apparatus.

10. A method for using a medium for a boiling-type cooler, comprising operating a boiling-type cooler accommodating the medium for the boiling-type cooler according to claim 1, at an operating temperature of −50 to 150° C.

11. The method according to claim 10, wherein a material of the boiling-type cooler is a heat pipe made of iron, copper or aluminium.

12. A method for using a medium for a boiling-type cooler, comprising operating a boiling-type cooler accommodating the medium for the boiling-type cooler according to claim 2, at an operating temperature of −50 to 150° C.

13. A method for using a medium for a boiling-type cooler, comprising operating a boiling-type cooler accommodating the medium for the boiling-type cooler according to claim 3, at an operating temperature of −50 to 150° C.

14. A method for using a medium for a boiling-type cooler, comprising operating a boiling-type cooler accommodating the medium for the boiling-type cooler according to claim 4, at an operating temperature of −50 to 150° C.

15. A method for using a medium for a boiling-type cooler, comprising operating a boiling-type cooler accommodating the medium for the boiling-type cooler according to claim 5, at an operating temperature of −50 to 150° C.

16. A method for using a medium for a boiling-type cooler, comprising operating a boiling-type cooler accommodating the medium for the boiling-type cooler according to claim 6, at an operating temperature of −50 to 150° C.

17. A method for using a medium for a boiling-type cooler, comprising operating a boiling-type cooler accommodating the medium for the boiling-type cooler according to claim 7, at an operating temperature of −50 to 150° C.

18. The method according to claim 15, wherein a material of the boiling-type cooler is a heat pipe made of iron, copper or aluminum.

19. The method according to claim 16, wherein a material of the boiling-type cooler is a heat pipe made of iron, copper or aluminum.

20. The method according to claim 17, wherein a material of the boiling-type cooler is a heat pipe made of iron, copper or aluminum.
